(19) United States
(12) Patent Application Publication
(10) Pub. No.: US 2008/0037053 A1
(43) Pub. Date: Feb. 14, 2008

(54) PRINTER WITH DYNAMIC PARAMETER CHANGE NOTIFICATION

(75) Inventors: Erin A. Boyd, Three Forks, MT (US); Ronald D. Parrish, Tucson, AZ (US); Stephen G. Price, Longmont, CO (US); Kenneth S. Shouldice, Firestone, CO (US); Larry D. Teklits, Loveland, CO (US)

Correspondence Address: LAW OFFICE OF CHARLES W. PETERSON, JR. - INFOPRINT, 435B Carlisle Dr., Herndon, VA, 20170, US

(73) Assignee: INTERNATIONAL BUSINESS MACHINES CORPORATION, Armonk, NY (US)

(21) Appl. No.: 11/464,457

(22) Filed: Aug. 14, 2006

(51) Int. Cl. G06F 3/12

(52) U.S. Cl. 358/1.15

(57) ABSTRACT

A printer system and method of managing the printer system. Printer sub-systems can register indicating system parameter affecting or, affected by, each. The printer is monitored for change requests to system parameters and, printer sub-systems are selectively notified of a requested parameter changes. Notified printer sub-systems respond indicating a time to apply each parameter change. Unless changes can be applied immediately, a change notification is displayed, requesting operator intervention and indicating a time for the intervention.

### CROSS REFERENCE TO RELATED APPLICATION

The present invention is related to U.S. patent application Ser. No. 11/262,395 (Attorney Docket No. BLD920050024US1) entitled “Notification of Changed Parameters In A Printing System” to Erin A. Boyd et al., filed Oct. 28, 2005, assigned to the assignee of the present invention and incorporated herein by reference.

### BACKGROUND OF THE INVENTION

1. Field of the Invention

The present invention generally relates to high performance printers and more particularly to embedded control system for monitoring and controlling print jobs being processed by a high performance printer.

2. Background Description

State of the art printers, such as laser printers, are complex multi-featured units that typically provide users with robust printing for professional results. Thus, these state of the art printers normally include an embedded control system for monitoring and controlling print jobs being processed by the printer. A typical such embedded system accepts numerous print parameters that may be changed on a job-by-job basis, e.g., with submission of a job or by an operator. For example, such parameters can indicate a change in memory allocation among different system components or among various types of data caches. Laser printers, for example, typically have a font cache, an overlay cache, and other caches from which printer units or subsystems may draw for printing particular jobs and, that must be allocated from a finite physical or virtual memory pool. Each of these caches may be selectively controlled by parameter changes. When each parameter is changed, when the change becomes effective depends upon the particular parameter and affected subsystem(s).

Ideally, the embedded control system applies new parameter values as soon as they are changed. Typically, however, the embedded control system frequently receives parameter changes that cannot be changed immediately. For example, new parameter values may be provided while the printer is currently processing a job by previous values. So, frequently, the printer must continue to use current parameters, at least until printer finishes the current job. Moreover, system architecture may require restarting or rebooting the printer before applying cache changes.

While some system parameter changes may not take effect until the next restart, or at the next device or protocol vary-on or enable operation, other parameters can change values contemporaneously and so, changing may not require rebooting or restarting. For example, the default font may be specified on the fly for most laser printers, typically by specifying a number of parameters, e.g., font typeface, font encoding and font size. Typically, these on-the-fly changes take effect upon commencement of a job, e.g., the start of the next print job.

So, whether the printer may accept and apply a changed parameter depends upon both the nature of the parameter being changed and the state of the system when the parameter change is requested. Some of these changes require manual intervention, such as system reboot. So, operator action is required for the system to reach the state where the parameter change takes effect. Consequently, it is necessary to inform the operator when such a parameter change has been made, both for information purposes (e.g., as a status update) and, to assure that the operator makes any necessary intervention. However, the embedded control system must take action to inform the user/operator when and only when a parameter change requires such intervention.

Accordingly, state of the art embedded control systems are designed to have parameter definitions that include a static value that indicates when a parameter change takes effect. For example, the IBM Infoprint 2060ES multifunction device of International Business Machines Corporation (IBM) has such an embedded control system. Unfortunately, these static values do not give any indication of the current printer system state and so, provide insufficient information, because they give no indication when parameter can take effect, especially changes that depend on the system state to take effect.

Instead, the IBM Infoprint 2060ES, for example, has static system state specific values defined, such as “attachment enable time” or “job start time.” Unfortunately, these state specific values require a full understanding of all system states that are affected by any changed system parameters and, further, an ability to track the system state as it changes. This is a complicated task that, to accomplish would overly complicate the system. In particular, adding system state transition complexity compounds the already complex parameter management in state of the art printer control systems. Further, new development and bug fixes can change system state definitions and system parameter handling dramatically. Consequently, the static table is very likely to become out of date very quickly, e.g., as the system evolves through new development and bug fixes.

Thus there is a need for a way to dynamically determine when printer system parameter changes are to take effect, contemporaneously with changes to the parameters and, further, with a determination of the parameter changes made by the system actually applying new parameter values and to provide a printer system operator with guidance for restarting the printer system only when necessary to effect pending parameter changes.

### SUMMARY OF THE INVENTION

It is therefore a purpose of the invention to dynamically determine when printer system parameter changes are to take effect;

It is another purpose of this invention dynamically determine when a printer system restart is required for parameter changes to take effect;

It is yet another purpose of the invention to automatically apply printer system parameters without operator intervention as appropriate, and automatically provide for operator intervention as identified by the printer system itself.

The present invention is related a printer system and method of managing the printer system. Printer sub-systems can register indicating system parameter affecting or, affected by, each. The printer is monitored for change requests to system parameters and, printer sub-systems are selectively notified of a requested parameter changes. Notified printer sub-systems respond indicating a time to apply each parameter change. Unless changes can be applied immediately, a change notification is displayed, requesting operator intervention and indicating a time for the intervention.

### BRIEF DESCRIPTION OF THE DRAWINGS

The foregoing and other objects, aspects and advantages will be better understood from the following detailed description of a preferred embodiment of the invention with reference to the drawings, in which:

FIG. 1A shows an application example of a preferred embodiment printer with an embedded control system for monitoring and controlling print jobs being processed by the printer.

FIG. 1B shows an example of the embedded control system in more detail.

FIG. 2 shows an operation example of a preferred embodiment printer.

### DESCRIPTION OF PREFERRED EMBODIMENTS

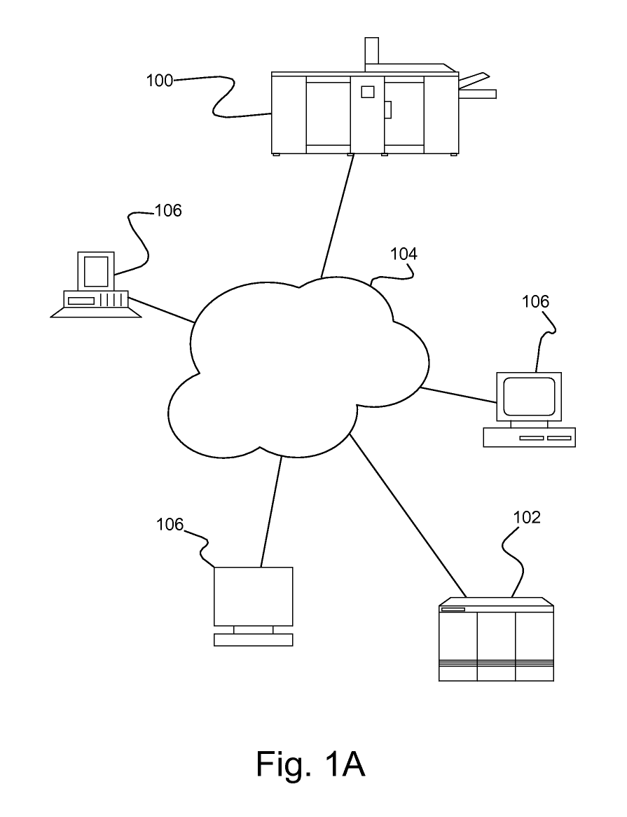

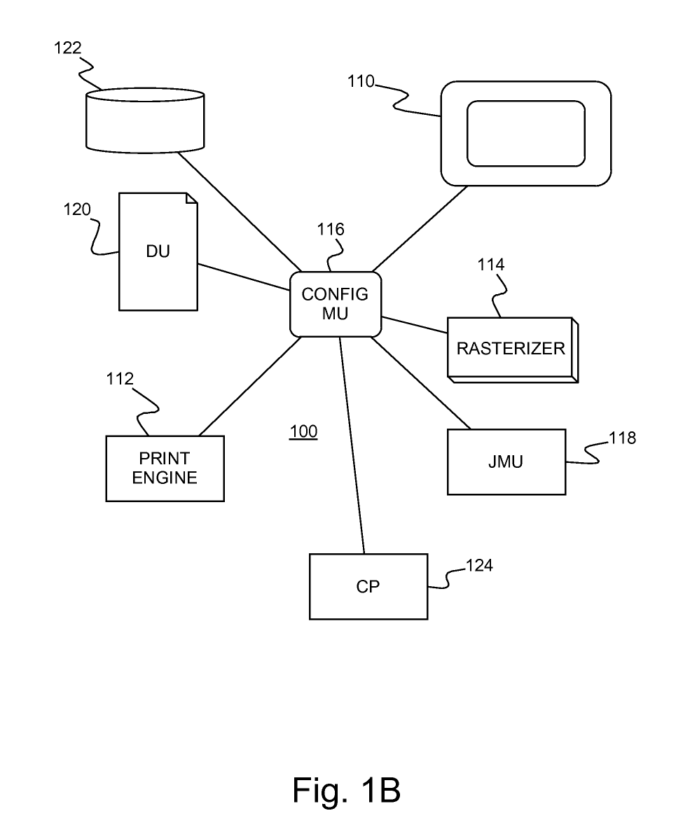

Turning now to the drawings, and more particularly, FIG. 1A shows an application example of a preferred embodiment printer 100 with an embedded control system for monitoring and controlling print jobs being processed by the printer. FIG. 1B shows an example of components or subsystems in a preferred embedded control system in more detail. The printer 100 is connected to one or more host systems 102, directly or, over a network 104. Also, remote terminals 106 are connected and pass print jobs to the printer 100, e.g., over the network 104. According to a preferred embodiment of the present invention, the printer 100 internally tracks print parameter changes, determines an appropriate action and time for making those parameter changes and automatically notifies a user operator, when operator intervention is appropriate.

Thus for example, the printer 100 may include an operator panel or console 110, a printer engine 112, a rasterizer 114, a configuration or parameter management unit 116, a job monitor unit 118, a duplexer 120, local storage 122 and a change propagator 124. The operator panel 110 provides a basic, local user interface. A typical operator panel 110 may be, simply, console lights and push buttons, or a more full featured interface, e.g., a color touchscreen with a keyboard and a mouse. The printer engine 112 interfaces to printer hardware that moves paper through the printer (e.g., selects a paper source and destination) and, for example, marks the page (e.g., selects fonts, inserts header/footers and watermarks and designates file location). The rasterizer 114 processes print job data, e.g. creates bitmaps from a raw print job for printing. For example, the rasterizer 114 may create full bitmap pages one at a time or, create bitmap bands. The configuration/parameter management unit 116 stores internal parameter values and settings. The job monitor unit 118 tracks jobs in the printer and may report the status of each job in the system. The job monitor unit 118 may also handle job operations such as cancel, hold and release. The duplexer 120 temporarily holds pages that have been printed on one side and returns held pages for printing the second/other side. The storage 122 may be shared amongst various caches and components 110, 112, 114, 116, 118. Also, jobs received for printing, but not yet printed, may be spooled to the local storage 122. Printer components (e.g., 110, 114, 116, 118, 122) may each use certain job parameters that may change for each print job. When a parameter is changed, the change propagator 124 sends messages to the printer components 110, 112, 114, 116, 118, 120, 122 that are registered for changes to that parameter.

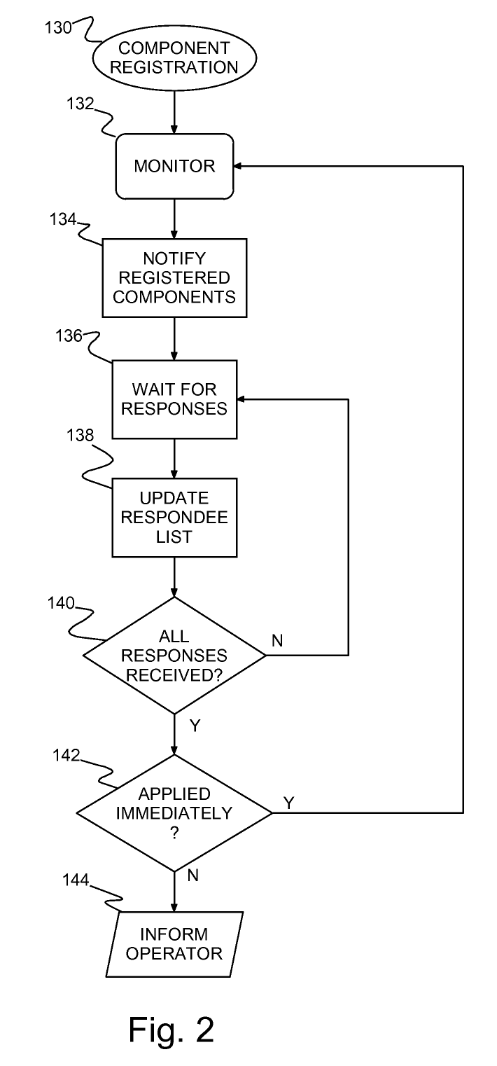

FIG. 2 shows an operation example of a preferred embodiment printer, e.g., 100 in FIGS. 1A-B. First in step 130, components (e.g., 110, 114, 118) register with the parameter management unit 116, e.g., indicating changes to which parameters affect the particular component 110, 114, 118, and for notification of changes to those related parameters. Also, the change propagator 124 initializes a component list as a data structure identifying the different potential responses from the registered components. In step 132, the parameter management unit 116 begins monitoring for parameter changes from incoming jobs and/or the operator panel 110 for operator inputs. Upon a parameter change, in step 134 the parameter management unit 116 sends messages to all components registered 110, 114, and/or 118 for the respective changing parameter. In step 136, the parameter management unit 116 waits for a response from each notified component 110, 114, and/or 118, which returns a message that indicates whether the changes can be applied immediately, or if not, what system state is required to apply the new value. As each response is received, in step 138 the change propagator 124 updates and maintains the list of all components that should respond to the change notification and the expected response. As the change propagator 124 receives responses from all notified components 110, 114, and/or 118, the responses are accumulated in the component list according to the list data structure. In step 140, the change propagator 124 updates the entries in the component list to identify when all responses have arrived and continues to wait in step 136 until all have responded. As the component list is updated, duplicate responses may be discarded. Once all responses are found to have arrived in step 140, then in step 142 the parameter management unit 116 examines the responses. If the parameter management unit 116 determines the selected change can be applied immediately, monitoring continues in step 132. If in step 142, however, the parameter management unit 116 determines that the change cannot be applied immediately, then in step 144, the parameter management unit 116 determines when and under what circumstances the parameter change can be applied (e.g., reboot or restart) and instructs the user/operator how to effect the parameter change.

Component registration in step 130 may be implemented in any of a number of suitable ways. For example, components 110, 114, 118, may register only for parameters they effect or that affect them. So in this example, for any component 110, 114, 118 that does not register for a parameter, the change propagator 124 lists as a “don't care” and, those “don't care” components are not notified for changes to that corresponding parameter. So, again in this example, while every registered component 110, 114, 118 must respond to changes for a registered parameter, there is no delay in applying a new parameter value from waiting for a response from a “don't care” component.

Alternately, each component can register for each parameters with one of two default application times. In this alternate approach, the change propagator 124 determines the time for parameter application based on the registered default for each component 110, 114, 118 for the respective parameter. So, for example, one default can indicate that the respective component always applies changes immediately, with the other default indicating that the component applies changes dependent upon the current printer state. In another example, the first default can indicate that parameter changes are always applied at a certain indicated point, such as immediately or at the next system restart with the other default again indicating that when the component applies changes depends upon the current printer state. These defaults may vary by component and so, need not apply to all parameters for each component or all components. Instead, parameter defaults may be individually selected for each parameter.

Optionally, instead of registering components 110, 114 and 118 in step 130, and skipping component registration entirely, the parameter management unit 116 broadcasts messages to all components for all parameter changes in step 134. In this optional approach in step 136, all components 110, 114, and 118 must respond to the parameter management unit 116 for every notification. Then, the change propagator 124 checks all of the responses. In this example, every reply must indicate whether the corresponding component can apply the new parameter value immediately, and if not, when the particular component can apply the new value. So, which of the components register, are notified and respond, depends upon the particular approach selected. If components register only for each related parameter or if the parameter management unit 116 broadcasts parameter change messages, then, all notified components respond. Otherwise, if default registration is provided for, the default determines which components are registered and so, will respond.

The instructions presented to the user/operator depend both on the responses from the components and the state of the system. If all of the components provide the same response, that response is the response shown to the user/operator. If some components respond differently than others, then the parameter management unit 116 further checks to determine if the responses may be consolidated. For example, the components may respond with “effective immediately,” “effective at next job start” and “effective at next system reboot.” So for this example, if the parameter management unit 116 receives all three responses, parameter change application cannot complete until the next reboot. Thus, in this example, only the response “effective at next system reboot” is presented to the user/operator. By contrast, however, if the components only respond with “effective at next network enable” and “effective at next print engine diagnostic test start,” both responses are presented to the user/operator.

Furthermore, “when-effective” values can be defined using any suitable approach and these values can be passed around the system. Preferably, however, all the values are defined as individual bits in a bit field. Then, the size of the accumulated list is fixed at the size of the particular bit field regardless of how many distinct values are specified. So, for example, “when-effective” values may be maintained for “Complete,” “Next Job,” “Next Enable,” “Next Appl Restart” and “Next OS Restart” bit fields defined as:

| | |
|---|---|
| #define PM_WHEN_EFFECTIVE_COMPLETE | 0x00000001 |
| #define PM_WHEN_EFFECTIVE_NEXT_JOB | 0x00000002 |
| #define PM_WHEN_EFFECTIVE_NEXT_ENABLE | 0x00000004 |
| #define | 0x00000008 |
| PM_WHEN_EFFECTIVE_NEXT_APPL_RESTART | |
| #define | 0x00000010 |
| PM_WHEN_EFFECTIVE_NEXT_OS_RESTART | |

So, marking the “Complete” bit field (e.g., with a “1”) indicates that the parameter value can be/has been applied immediately. Marking the “Next Job” bit field indicates that the parameter value can be applied to the next job that runs. Marking the “Next Enable” bit field indicates that the parameter value will be applied the next time the network or attachment is enabled. Marking the “Next Appl Restart” bit field indicates that the parameter value will be applied the next time the embedded application portion of the system is restarted. Marking the “Next OS Restart” bit field indicates that the parameter value will be applied the next time the operating system is restarted. Since the size of each particular bit field is fixed, as the change propagator 124 receives responses, those responses are simply accumulated by ORing the respective incoming when-effective values with the corresponding accumulated value. Further, additional values can be defined as appropriate for the particular system.

Advantageously, printer system parameters are changed automatically without operator intervention, unless the printer system itself identifies changes that require operator intervention. Further, the operator is provided with guidance regarding the type of intervention required and the appropriate time for taking necessary action.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

We claim:

1. A method of managing a printer system, said method comprising the steps of:
a) monitoring a printer system for change requests to system parameters;
b) notifying a plurality of printer sub-systems of a requested change to an identified parameter;
c) receiving responses from notified said printer sub-systems;
d) determining a time to apply said change to identified parameter; and
e) selectively displaying a notification of said change.

2. A method as in claim 1, before the step (a) of monitoring said method further comprises registering said plurality of printer sub-systems, each registered sub-system indicating ones of said system parameters.

3. A method as in claim 2, wherein the step (b) of notifying said plurality of printer sub-systems comprises notifying ones of said plurality of printer sub-systems registered for the changing said identified parameter.

4. A method as in claim 3, wherein the step (c) of receiving responses comprises receiving responses from said ones of said plurality of printer sub-systems registered for said changing identified parameter.

5. A method as in claim 2, wherein each registered sub-system indicating one of two defaults for each of said system parameters.

6. A method as in claim 5, wherein said two defaults comprise:
an indication that a respective system parameter is applied immediately; and
an indication that said respective system parameter is applied dependent upon printer state.

7. A method as in claim 5, wherein said two defaults comprise:
an indication that a respective system parameter is applied at an indicated point; and
an indication that said respective system parameter is applied dependent upon current printer state.

8. A method as in claim 7, wherein said indicated point is at a next printer restart.

9. A method as in claim 1, wherein the step (b) of notifying said plurality of printer sub-systems notifies all of said plurality of printer sub-systems.

10. A method as in claim 1, wherein the step (e) of selectively displaying notification comprises displaying only a request for operator intervention unless said identified parameter is changed immediately.

11. A printer system comprising:
a plurality of printer sub-systems;
means for monitoring parameter changes to each of said plurality of printer sub-systems;
means for selectively notifying said each of the plurality of printer sub-systems of parameter changes;
means for determining a time for applying each of said parameter changes; and
means for requesting operator intervention responsive to a determination that any of said plurality of printer sub-systems cannot apply a parameter change until occurrence of a predetermined printer system state change.

12. A printer system as in claim 11, wherein the means for notifying said plurality of printer sub-systems broadcasts notification to all of said plurality of printer sub-systems.

13. A printer system as in claim 11, further comprising means for registering said plurality of printer sub-systems.

14. A printer system as in claim 13, wherein said means for registering lists each registered sub-system and indicates ones of said system parameters, and the means for determining comprises means for receiving responses from said ones of said plurality of printer sub-systems registered for said changing identified parameter.

15. A printer system as in claim 13, wherein each registered sub-system indicates one of two defaults for each of said system parameters.

16. A printer system as in claim 15, wherein said two defaults comprise:
an indication that a respective system parameter is applied immediately; and
an indication that said respective system parameter is applied dependent upon printer state.

17. A printer system as in claim 15, wherein said two defaults comprise:
an indication that a respective system parameter is applied at an indicated point; and
an indication that said respective system parameter is applied dependent upon current printer state.

18. A printer system as in claim 17, wherein said indicated point is at a next printer restart.
